(19) United States
(12) Patent Application Publication
(10) Pub. No.: US 2006/0292336 A1
(43) Pub. Date: Dec. 28, 2006

(54) Honeycomb structured body and method of manufacturing the same

(76) Inventors: Kazushige Ohno, Gifu (JP); Masafumi Kunieda, Gifu (JP); Kazutake Ogyu, Gifu (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/335,660

(22) Filed: Jan. 20, 2006

Related U.S. Application Data
(63) Continuation of application No. PCT/JP05/11665, filed on Jun. 24, 2005.

(51) Int. Cl. B32B 3/12; B32B 37/00; C04B 37/00; C04B 33/32; B29C 65/00; C04B 33/34

(52) U.S. Cl. 428/116; 264/630; 156/87; 156/89.22

(57) ABSTRACT

The honeycomb structured body of the present invention is a honeycomb structured body including: a honeycomb block which has a flat-shaped cross section and has a structure in which plural honeycomb units are bonded to one another through sealing material layers, each honeycomb unit including as a main component a porous ceramic and having in the longitudinal direction a number of cells placed in parallel with a cell wall therebetween; and a sealing material layer provided on an outer peripheral portion of the honeycomb block. Herein, each honeycomb unit contains inorganic fibers and/or whiskers in addition to inorganic particles, and the sealing material layer between the honeycomb units on the cross section perpendicular to the longitudinal direction is formed such that the direction thereof is diagonal to the major axis of a shape constituting the contour of the cross section.

### CROSS-REFERENCE TO RELATED APPLICATIONS

This application claims benefit of priority based on PCT/JP2005/011665 filed on Jun. 24, 2005. The contents of this application are incorporated herein by reference in their entirety.

### BACKGROUND OF THE INVENTION

1. Field of the Invention

The present invention relates to a honeycomb structured body used as a catalyst support and the like.

2. Discussion of the Background

Conventionally, a honeycomb catalyst generally used for exhaust gas conversion of an automobile is manufactured by supporting a high specific surface area material such as active alumina and the like and a catalyst metal such as platinum and the like on a surface of a cordierite-based honeycomb structured body that has an integral structure and a low thermal expansion property. Moreover, an alkaline earth metal such as Ba and the like is supported thereon as a NOx occlusion agent, so as to be used for treating NOx in an atmosphere with excessive oxygen such as an atmosphere in a lean burn engine and a diesel engine.

Here, in order to improve the converting performance, it is necessary to increase the possibility of contact between exhaust gases and the catalyst noble metal as well as the NOx occlusion agent. For this purpose, it is necessary for the support to have a higher specific surface area and for the noble metal to have a smaller grain size and to be dispersed in a high level. Therefore, various honeycomb structured bodies with devised cell shape, cell density, thickness of cell walls, and the like have been proposed (for example, see JP-A 10-263416).

With respect to the honeycomb structured body made of a high specific surface area material, a honeycomb structured body that has been subjected to extrusion molding together with inorganic fibers and an inorganic binder has been known (for example, see JP-A 5-213681).

As the honeycomb structured body used for converting exhaust gases, the following has been known: a honeycomb structured body in which plural honeycomb units are bonded to one another through sealing material layers to form a honeycomb block, each unit mainly composed of a porous ceramic made of silicon carbide, and having in the longitudinal direction a large number of cells placed in parallel with a cell wall therebetween, thereafter a sealing material layer being formed on the outer peripheral portion of the honeycomb block.

Most of the honeycomb structured body of this type are round in the cross-sectional shape perpendicular to the longitudinal direction; however, in recent years, honeycomb structured bodies having various shapes in the cross-section perpendicular to the longitudinal direction, for example, a racetrack shape, an elliptical shape, an almost triangular shape, an almost trapezoidal shape and the like, have also been proposed (for example, see JP-A 2002-273130, JP-A 2003-260322, WO 03/078026 A1 and JP-A 2003-181233 and the like).

FIG. 1 is a perspective view that schematically shows a honeycomb filter made of such a honeycomb structured body. Moreover, FIG. 2A is a perspective view that schematically shows one example of a honeycomb unit that constitutes a honeycomb filter shown in FIG. 1, and FIG. 2B is a cross-sectional view taken along line A-A of FIG. 2A.

As shown in FIG. 1, a honeycomb filter 100 has a structure in which a plurality of honeycomb units 110 made of silicon carbide and the like are bound together through sealing material layers 101 to constitute a honeycomb block 105, and a coat layer 102 is formed around this honeycomb block 105. The end face of the honeycomb filter 100 has a racetrack shape, and the sealing material layer between the honeycomb units on the cross section perpendicular to the longitudinal direction is configured to be almost perpendicular to or parallel to the major axis of the shape constituting the contour of the cross section.

As shown in FIGS. 2A and 2B, the honeycomb unit 110 is configured that it has a large number of cells 111 placed in parallel with one another in the longitudinal direction, and that exhaust gases which flow in pass through the cells 111, being converted thereby.

The contents of JP-A10-263416, JP-A5-213681, JP-A2002-273130, JP-A 2003-260322, International Publication No. 03/078026A1, and JP-A 2003-181233 are incorporated herein by reference in their entirety.

### SUMMARY OF THE INVENTION

The honeycomb structured body of the present invention is a honeycomb structured body comprising:

a honeycomb block which has a flat-shaped cross section and has a structure in which plural honeycomb units are bonded to one another through sealing material layers, each unit having in the longitudinal direction a large number of cells placed in parallel with a cell wall therebetween, and

a sealing material layer provided on an outer peripheral portion of the honeycomb block,

wherein

each of the honeycomb units comprises inorganic fibers and/or whiskers in addition to inorganic particles, and

the sealing material layer which is formed between the honeycomb units on the cross section perpendicular to the longitudinal direction is formed such that the direction thereof is diagonal to the major axis of a shape constituting the contour of the cross section.

In the above-mentioned honeycomb structured body, the cross-sectional area on a cross section perpendicular to the longitudinal direction of said honeycomb unit is desirably about 5 to about 50 cm², more desirably about 6 to about 40 cm², and more desirably about 8 to about 30 cm².

Also in the above-mentioned honeycomb structured body, the smaller of the angles of which the sealing material layer between the honeycomb units on the cross section perpendicular to the longitudinal direction and the major axis of the shape (outer peripheral shape) constituting the contour of the cross section make is desirably within the range of about 5 to about 85°, more desirably about 15 to about 75°, and more desirably about 30 to about 60°.

The sealing material layer desirably has a thickness of about 0.5 to about 2 mm.

In the above-mentioned honeycomb structured body, it is desirable that the total sum of cross-sectional areas of the honeycomb units on the cross section perpendicular to the longitudinal direction accounts for about 85% or more of the cross-sectional area of the honeycomb structured body on the cross section perpendicular to the longitudinal direction.

In the above-mentioned honeycomb structured body, it is desirable that the inorganic particles comprise of at least one member selected from the group consisting of alumina, silica, zirconia, titania, ceria, mullite and zeolite.

In the above-mentioned honeycomb structured body, it is desirable that the inorganic fibers and/or whiskers comprise of at least one member selected from the group consisting of alumina, silica, silicon carbide, silica-alumina, glass, potassium titanate, and aluminum borate.

In the above-mentioned honeycomb structured body, it is desirable that the honeycomb unit is manufactured by using an inorganic binder. The inorganic binder comprises of at least one member selected from the group consisting of alumina sol, silica sol, titania sol, water glass, sepiolite and attapulgite.

On the honeycomb structured body, it is desirable that a catalyst is supported, and that the catalyst contains at least one member selected from the group consisting of noble metal, alkali metal, alkaline earth metal and oxide.

The sealing material layer desirably comprises at least inorganic fibers and/or inorganic particles in addition to inorganic binder.

The inorganic binder desirably comprises silica sol and/or alumina sol.

The inorganic fibers desirably comprise at least one member selected from the group consisting of silica-alumina fibers, mullite fibers, alumina fibers and silica fibers.

The inorganic particles desirably comprise at least one member selected from the group consisting of oxides, carbides and nitrides.

The sealing material layer desirably is manufactured by using inorganic fibers and/or inorganic particles in addition to an inorganic binder and an organic binder.

The organic binder desirably comprises at least one member selected from the group consisting of polyvinyl alcohol, methyl cellulose, ethyl cellulose and carboxymethyl cellulose.

It is desirable that the sealing material layer further comprises at least one member selected from the group consisting of balloons, spherical acrylic particles and graphite.

The balloons desirably comprise at least one member selected from the group consisting of alumina balloons, glass micro-balloons, shirasu balloons, fly ash balloons (FA balloons) and mullite balloons.

Moreover, it is desirable that the above-mentioned honeycomb structured body is used for exhaust gas conversion of a vehicle.

According to the present invention, also provided is a manufacturing method of a honeycomb structured body which comprises

a honeycomb block which has a flat-shaped cross section and has a structure in which plural honeycomb units are bonded to one another through sealing material layers, each unit having in the longitudinal direction a large number of cells placed in parallel with a cell wall therebetween, and

a sealing material layer provided on an outer peripheral portion of the honeycomb block,

wherein

the honeycomb block which has a flat-shaped cross section is fabricated by subjecting the plural honeycomb units bonded to one another to a cutting process such that each sealing material layer between the honeycomb units on the cross section perpendicular to the longitudinal direction is formed diagonal to the major axis of a shape constituting the contour of the cross section.

### BRIEF DESCRIPTION OF THE DRAWINGS

FIG. 1 is a perspective view that schematically shows one example of a conventional honeycomb structured body.

FIG. 2A is a perspective view that schematically shows one example of a honeycomb unit that constitutes a conventional honeycomb structured body, and FIG. 2B is a cross-sectional view taken along line A-A of the honeycomb unit shown in FIG. 2A.

FIG. 3A is a perspective view that schematically shows one example of a honeycomb structured body of the present invention, and FIG. 3B shows the major axis and the minor axis of the honeycomb structured body shown in FIG. 3A.

FIG. 4A is a perspective view that schematically shows one example of a honeycomb unit that constitutes the honeycomb structured body of the present invention, and FIG. 4B is a cross-sectional view taken along line A-A of the honeycomb unit shown in FIG. 4A.

FIG. 5 is a cross-sectional view that schematically shows a cross section perpendicular to the longitudinal direction of another example of the honeycomb structured body of the present invention.

FIG. 6 is a cross-sectional view that schematically shows a cross section perpendicular to the longitudinal direction of still another example of the honeycomb structured body of the present invention.

FIG. 7 is a cross-sectional view that schematically shows a cross section perpendicular to the longitudinal direction of yet another example of the honeycomb structured body of the present invention.

FIG. 8 is a cross-sectional view that schematically shows one example of an exhaust-gas conversion device for a vehicle, in which the honeycomb structured body of the present invention is installed.

FIG. 9 is a scanning electronic microscopic (SEM) photograph of a cell wall of the honeycomb unit in accordance with Example 1.

FIG. 10A is a front view that shows a vibration device used for a vibration test, and FIG. 10B is a side view of the vibration device.

FIG. 11 is a schematic diagram that shows a pressure-loss measuring device.

### DESCRIPTION OF THE EMBODIMENTS

The honeycomb structured body of the present invention is a honeycomb structured body comprising:

a honeycomb block which has a flat-shaped cross section and has a structure in which plural honeycomb units are bonded to one another through sealing material layers, each unit having in the longitudinal direction a large number of cells placed in parallel with a cell wall therebetween, and

a sealing material layer provided on an outer peripheral portion of the honeycomb block,

wherein

each of the honeycomb units includes inorganic fibers and/or whiskers in addition to inorganic particles, and

the sealing material layer which is formed between the honeycomb units on the cross section perpendicular to the longitudinal direction is formed such that the direction thereof is diagonal to the major axis of a shape constituting the contour of the cross section.

According to the honeycomb structured body of present invention, since the sealing material layer between the honeycomb units on the cross section perpendicular to the longitudinal direction is formed such that the direction thereof is diagonal to the major axis of a shape constituting the contour of the cross section, a concentration of stress hardly occurs between the sealing material layers formed near the minor axis, that is, between the sealing material layer inside the honeycomb structured body that serves as an adhesive layer and the sealing material layer formed on the outer periphery that serves as a coat layer; consequently, the sealing material layers are hardly damaged during use, and thus the adhesion strength can be properly maintained in the sealing material layers.

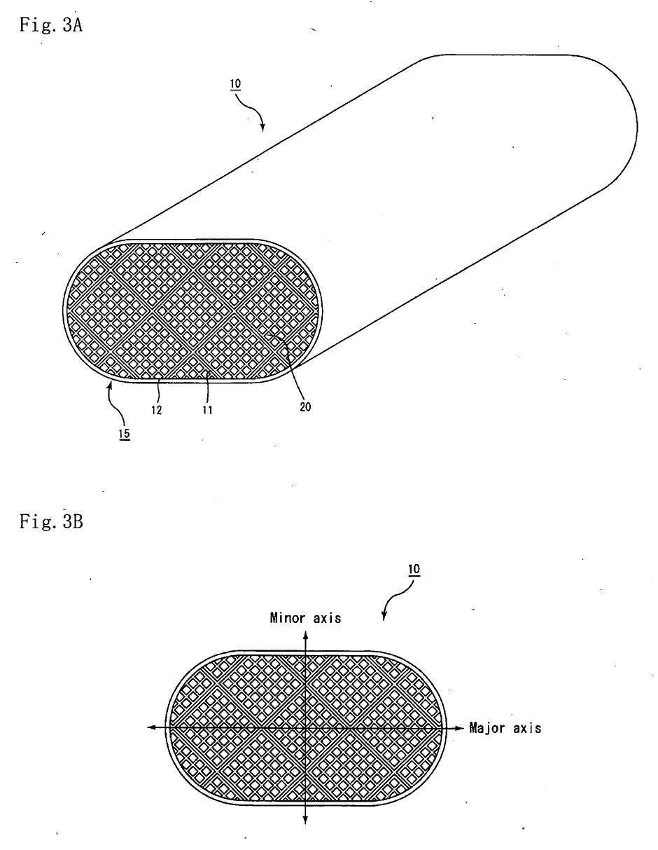

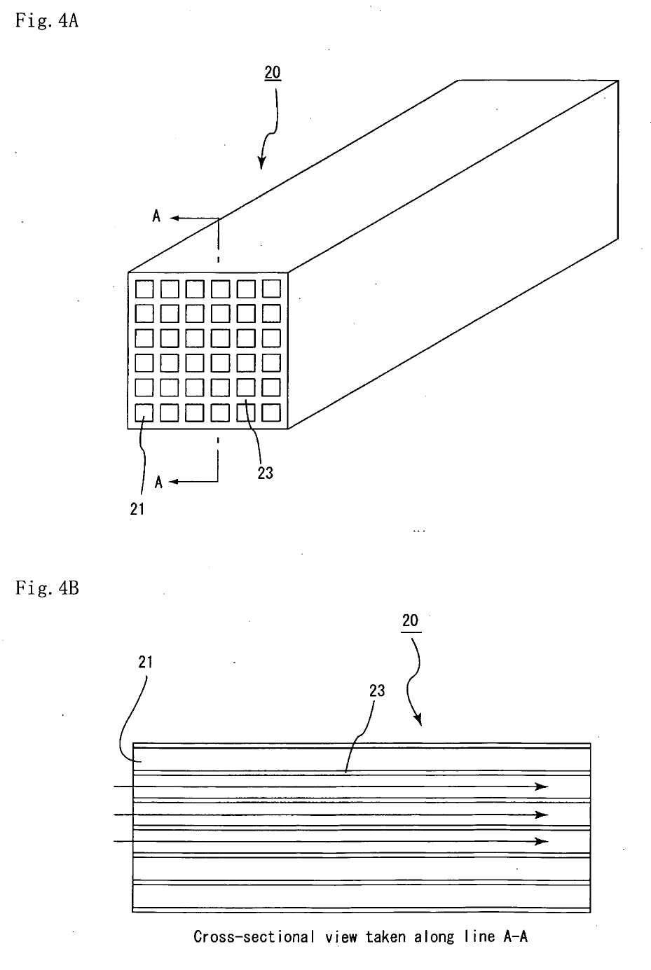

FIG. 3A is a perspective view that schematically shows one example of the honeycomb structured body of the present invention, and FIG. 3B shows the major axis and the minor axis of the honeycomb structured body shown in FIG. 3A. FIG. 4A is a perspective view that schematically shows a honeycomb unit that constitutes the honeycomb structured body of the present invention, and FIG. 4B is a cross-sectional view taken along line A-A of the honeycomb unit shown in FIG. 4A.

As shown in FIG. 3A, the honeycomb structured body 10 has a structure in which a plurality of honeycomb units 20, each containing inorganic fibers and/or whiskers in addition to inorganic particles, are bound together through sealing material layers (adhesive layers) 11 to form a honeycomb block 15, and a sealing material layer (coat layer) 12 is formed around this honeycomb block 15. The end face of this honeycomb structured body 10 has a racetrack shape, and the sealing material layer (adhesive layer) 11 between the honeycomb units on the cross section perpendicular to the longitudinal direction is formed such that the direction thereof is diagonal to the major axis of a shape constituting the contour of the cross section.

As shown in FIGS. 4A and 4B, the honeycomb unit 20 has a structure in which a large number of cells 21 are placed in parallel with one another in the longitudinal direction, and the exhaust gases which flow into the cells 21 pass through the inside of the cells 21, being converted thereby.

In the honeycomb unit 20, although not shown in the figures, a catalyst for converting exhaust gases is supported on the cell wall. The above-mentioned catalyst will be described later.

In the present invention, since the sealing material layer (adhesive layer) 11 between the honeycomb units 20 on the cross section perpendicular to the longitudinal direction is formed such that the direction thereof is diagonal to the major axis of a shape constituting the contour of the cross section (racetrack shape), there are many portions at which the angle the sealing material layer (adhesive layer) 11 between the honeycomb units 20 on the cross section perpendicular to the longitudinal direction and the sealing material layer (coat layer) 12 make is diagonal.

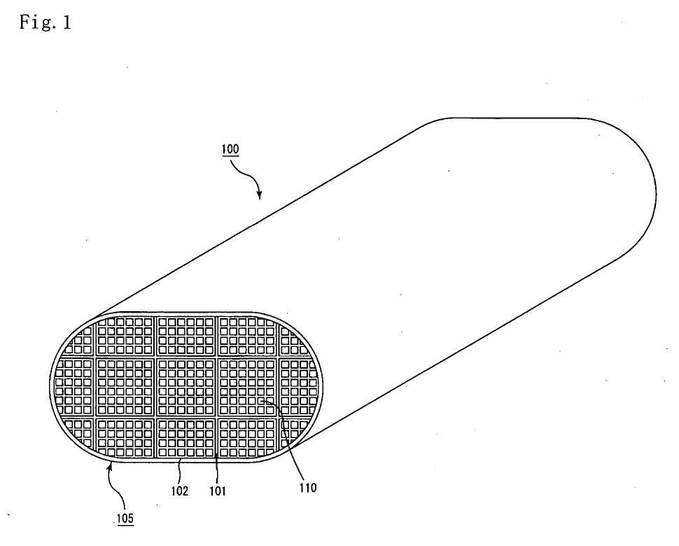

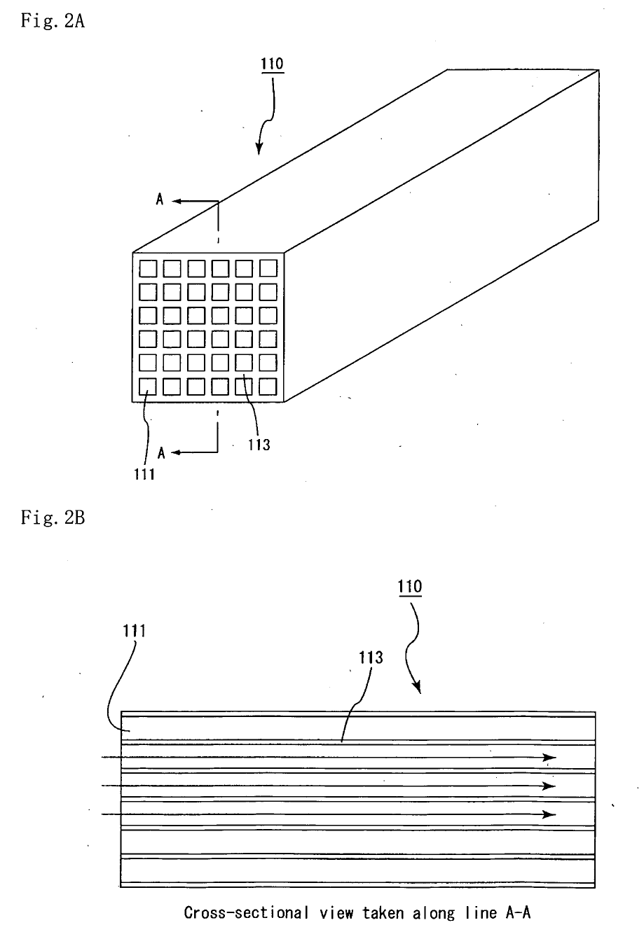

As in the case of the conventional structure, as shown in FIG. 1, when the sealing material layer between the honeycomb units on the cross section perpendicular to the longitudinal direction is formed such that it is perpendicular to the major axis of a shape constituting the contour of the cross section, there are many portions at which the angle the sealing material layer (adhesive layer) 101 and the sealing material layer (coat layer) 102 make is almost perpendicular, thereby making the area at which the two layers are made in contact with each other to become small.

At the time of a temperature rise and the like, a stress is exerted between the sealing material layer (adhesive layer) 101 and the sealing material layer (coat layer) 102, and since the stress is perpendicularly imposed on the sealing material layer (coat layer) 102 and since the contact area between the two layers is small, the stress becomes greater, making the sealing material layer (coat layer) 102 to be damaged easily.

In the present invention, however, since there are many portions at which the sealing material layer (adhesive layer) 11 between the honeycomb units 20 on the cross section perpendicular to the longitudinal direction is formed such that the direction thereof is diagonal to the sealing material layer (coat layer) 12, and since the contact area between the sealing material layer (adhesive layer) 11 and the sealing material layer (coat layer) 12 is large, the strength to be imposed perpendicularly on the sealing material layer (coat layer) 12 becomes smaller, and the sealing material layer (coat layer) 12 is hardly damaged (see FIG. 3).

In the present invention, it is desirable that the smaller of the angles of which the sealing material layer 11 between the honeycomb units on the cross section perpendicular to the longitudinal direction and the major axis of the outer peripheral shape make is about 5°, more desirably about 15°, still more desirably about 30° in minimum value, and desirably about 85°, more desirably about 75°, still more desirably about 60° in maximum value.

When the angle the sealing material layer 11 between the honeycomb units on the cross section perpendicular to the longitudinal direction and the major axis of the outer peripheral shape make is in the range of about 5° to about 85°, there is a great difference from when the angle is perpendicular. As a result, it is hardly likely that the sealing material layer is damaged by a thermal shock and the like.

Moreover, in the present invention, it is desirable that the area on the cross section perpendicular to the longitudinal direction of each honeycomb unit constituting the honeycomb structured body is about 5 cm², more desirably about 6 cm², still more desirably about 8 cm² in lower limit. In contrast, it is desirable that the upper limit thereof is about 50 cm², more desirably about 40 cm², and still more desirably about 30 cm².

When the cross-sectional area of the honeycomb unit perpendicular to the longitudinal direction is about 5 to about 50 cm², since the cross-sectional area is small, there is not so much temperature difference between the center portion and the peripheral portion of the honeycomb unit even upon a temperature rise and the like, and thus the thermal stress does not become so high, leading to high durability to thermal shock.

In addition, since the specific surface area per unit area of the honeycomb unit is maintained in a great level, it becomes possible to disperse catalyst components in a high level, and also to maintain the proper shape of the honeycomb structured body even when external forces such as thermal shock and vibration are applied thereto.

Here, the specific surface area per unit volume can be calculated by the after-mentioned expression (1).

In the present specification, when the honeycomb structured body includes plural honeycomb units which have different cross-sectional areas, the cross-sectional area of the honeycomb unit on the cross section perpendicular to the longitudinal direction refers to the cross-sectional area on the cross section perpendicular to the longitudinal direction of the honeycomb unit that serves as a basic unit constituting the honeycomb structured body, that is, normally, the largest cross-sectional area on the cross section perpendicular to the longitudinal direction of the honeycomb unit.

The honeycomb units that constitute the honeycomb structured body of the present invention include inorganic fibers and/or whiskers in addition to inorganic particles.

In such a honeycomb structured body which includes inorganic fibers and/or whiskers in addition to inorganic particles, the specific surface area is improved by the inorganic particles, and the strength of the porous ceramic is improved by the inorganic fibers and/or whiskers.

As the inorganic particles, it is desirable that particles made of alumina, silica, zirconia, titania, ceria, mullite, zeolite, and the like are used. These particles may be used independently, or two or more kinds thereof may be used in combination.

Among these, it is especially desirable to use alumina particles.

It is desirable that the inorganic fibers and whiskers include inorganic fibers and whiskers made of alumina, silica, silicon carbide, silica-alumina, glass, potassium titanate, aluminum borate, and the like.

These particles may be used independently, or two or more kinds thereof may be used in combination.

The aspect ratio (length/diameter) of the above-mentioned inorganic fibers and whiskers is about 2, more desirably about 5, and still more desirably about 10 in lower limit, and about 1000, more desirably about 800, and still more desirably about 500 in upper limit.

Here, when there is a distribution in the aspect ratio, the aspect ratio of the inorganic fibers and whiskers is indicated by the average value thereof.

It is desirable that the amount of the inorganic particles contained in the honeycomb unit is about 30% by weight, more desirably about 40% by weight, and still more desirably about 50% by weight in lower limit.

In contrast, it is desirable that the upper limit thereof is about 97% by weight, more desirably about 90% by weight, still more desirably about 80% by weight, and especially desirable when about 75% by weight.

When the content of the inorganic particles is within the range of about 30% and about 97% by weight, since the amount of inorganic particles that devote to improvements of the specific surface area becomes relatively large, it is possible to make the specific surface area of the honeycomb structured body large, and to disperse a catalyst component in a high level upon supporting the catalyst component. Further, the amount of the inorganic fibers and/or whiskers that devote to improvements in strength becomes relatively large, leading to improvement in the strength of the honeycomb structured body.

It is desirable that the total amount of the inorganic fibers and/or whiskers contained in the honeycomb unit is about 3% by weight, more desirably about 5% by weight, and still more desirably about 8% by weight in lower limit, and that the upper limit thereof is about 70% by weight, more desirably about 50% by weight, still more desirably about 40% by weight, and especially desirable when about 30% by weight.

When the total amount of the inorganic fibers and/or whiskers is in the range of about 3% to about 50% by weight, it is possible to suppress the reduction of the strength of the honeycomb structured body. Further, since the amount of inorganic particles that devote to improvements of the specific surface area is relatively large, it is possible to increase the specific surface area of the honeycomb structured body, and to disperse a catalyst component in a high level upon supporting the catalyst component.

Moreover, it is desirable that the honeycomb unit is manufactured by using a mixture containing the inorganic particles, the inorganic fibers and/or whiskers and an inorganic binder.

By thus using a mixture containing the inorganic binder, a porous ceramic that has sufficient strength can be obtained even when the temperature at which a raw molded body is fired is set to a low level.

As the inorganic binder, an inorganic sol, a clay-type binder and the like can be used, and specific examples of the inorganic sol include, for example, alumina sol, silica sol, titania sol, water glass and the like. Moreover, examples of the clay-type binder include, for example, clays having a double-chain structure, such as clay, kaolin, montmorillonite, sepiolite, attapulgite and the like, and clays of the like. These may be used independently, or two or more kinds thereof may be used in combination.

Among these, it is desirable that the inorganic binder comprising at least one kind selected from the group consisting of alumina sol, silica sol, titania sol, water glass, sepiolite and attapulgite is used.

It is desirable that the amount of the inorganic binder that serves as a solid component of a raw material paste prepared in a manufacturing process which will be described later is about 5% by weight, more desirably about 10% by weight, and still more desirably about 15% by weight in lower limit, and that the upper limit thereof is about 50% by weight, more desirably about 40% by weight, and still more desirably about 35% by weight.

When the content of the inorganic binder is about 50% by weight or less, favorable moldability is maintained.

In the honeycomb structured body 10 of the present invention, as shown in FIG. 3A, the sealing material layer (adhesive layer) 11 is formed between the honeycomb units 20 so as to also function as an adhesive to bind the plurality of honeycomb units 20 together. In contrast, the sealing material layer (coat layer) 12 that is formed on the outer peripheral face of a honeycomb block 15 so as to function as a sealing member that prevents exhaust gases from leaking from the outer peripheral face of the honeycomb block 15 when the honeycomb structured body 10 is placed in an exhaust passage of an internal combustion engine.

Here, in the honeycomb structured body 10, the sealing material layer 11 and the sealing material layer 12 may be made of the same material, or from different materials. When the sealing material layer 11 and the sealing material layer 12 are made of the same material, the blending ratio of materials may be the same or may be different.

It is desirable that the sealing material layer 11 has the thickness of about 0.5 mm in lower limit, and about 2 mm in upper limit.

When the thickness of the sealing material layer (adhesive layer) is in the range of about 0.5 to about 2 mm, sufficient adhesion strength can be secured. Further, the specific surface area per unit volume of the honeycomb structured body is increased, making it easy to disperse a catalyst component sufficiently in a high level when the catalyst component is dispersed. Further, when the thickness of the sealing material layer is about 2 mm or less, the pressure loss may be suppressed.

The material for forming the sealing material layer 11 and the sealing material layer 12 is not particularly limited, and may include, for example, a material composed of an organic binder and inorganic fibers and/or inorganic particles in addition to an inorganic binder, and materials of the like.

Examples of the inorganic binder include silica sol, alumina sol and the like. These may be used independently, or two or more kinds thereof may be used in combination. Among the inorganic binders, it is desirable for silica sol to be used.

Examples of the organic binder include polyvinyl alcohol, methyl cellulose, ethyl cellulose, carboxymethyl cellulose and the like. These may be used independently, or two or more kinds thereof may be used in combination. Among the organic binders, it is desirable for carboxymethyl cellulose to be used.

Examples of the inorganic fibers include ceramic fibers such as silica-alumina fibers, mullite fibers, alumina fibers, silica fibers and the like. These may be used independently, or two or more kinds thereof may be used in combination. Among the inorganic fibers, it is desirable for alumina fibers and silica-alumina fibers to be used.

Examples of the inorganic particles include particles made of oxides, carbides, nitrides and the like, and specific examples thereof include inorganic powders made of alumina, silicon carbide, silicon nitride, boron nitride and the like. These may be used independently, or two or more kinds thereof may be used in combination.

Moreover, a pore-forming agent, such as balloons that are fine hollow spheres composed of oxide-based ceramics, spherical acrylic particles, graphite and the like, may be added to the above-mentioned sealing material paste, if necessary.

The above-mentioned balloons are not particularly limited, and may include, for example, alumina balloons, glass micro-balloons, shirasu balloons, fly ash balloons (FA balloons), mullite balloons and the like. Among these, it is desirable for the alumina balloons to be used.

In the honeycomb structured body of the present invention, it is desirable that the total sum of cross-sectional areas of the honeycomb units on the cross sections perpendicular to the longitudinal direction accounts for about 85% or more, more desirably about 90% or more of the cross sectional area of the honeycomb structured body on the cross section perpendicular to the longitudinal direction.

When the percentage is about 85% or more, the ratio of the cross-sectional areas of the sealing material layers therein becomes smaller, while the total cross-sectional area of the honeycomb units is increased, making the specific surface area on which a catalyst is supported relatively larger, which as a result provides a relatively small pressure loss.

When the percentage is about 90% or more, the pressure loss can be further reduced.

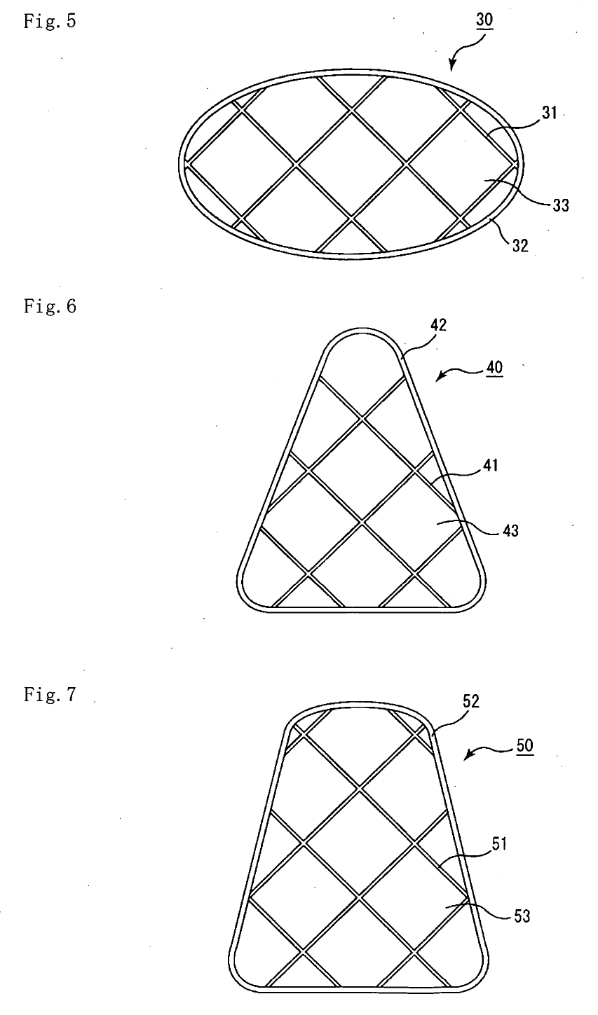

Although the honeycomb structured body 10 shown in FIG. 3 has a racetrack shape, the shape of the honeycomb structured body of the present invention is not particularly limited to this shape, as long as its cross section has a flat shape, and for example, as shown in FIG. 5, the shape of the cross section perpendicular to the longitudinal direction may be formed into an elliptical shape, or may be formed into shapes as shown in FIGS. 6 and 7. Here, in FIGS. 5 to 7, reference numerals 31, 41 and 51 represent inner sealing material layers (adhesive layers); 32, 42 and 52 represent outer peripheral sealing material layers (coat layers); and 33, 43 and 53 represent honeycomb units.

The honeycomb structured body 10 desirably has a catalyst capable of converting CO, HC, NOx and the like in exhaust gases supported thereon.

When such a catalyst is supported thereon, the honeycomb structured body 10 is allowed to function as a catalyst converter for converting CO, HC, NOx and the like contained in exhaust gases.

The catalyst supported on the honeycomb structured body 10 is not particularly limited as long as it can convert CO, HC, NOx and the like in exhaust gases, and they may include, for example, noble metals such as platinum, palladium, rhodium and the like, alkali metals, alkaline earth metals and oxides.

These may be used independently, or two or more kinds thereof may be used in combination.

Next, description of one example of a manufacturing method of the honeycomb structured body of the present invention will be given.

First, by using a raw material paste containing inorganic fibers and/or whiskers in addition to inorganic particles, an extrusion molding is carried out to prepare a ceramic molded body having a square pillar shape.

It is necessary for the raw material paste to be made of the above-mentioned inorganic fibers and/or whiskers in addition to inorganic particles, and in addition thereto, the inorganic binder, the organic binder, a dispersant and a molding assistant may be added appropriately, so that the resulting paste can be used as the raw material paste.

The above-mentioned raw material paste may be prepared by mixing the various components using an attritor and the like, and further kneading it sufficiently using a kneader and the like.

Although examples of the organic binder are not particularly limited, they may include, for example, methyl cellulose, carboxymethyl cellulose, hydroxyethyl cellulose, polyethylene glycol, phenol resins, epoxy resins and the like.

These may be used independently, or two or more kinds thereof may be used in combination.

It is preferable that the blending quantity of the organic binder is in the range of about 1 to about 10 parts by weight out of 100 parts by weight of a total of the inorganic particles, the inorganic fibers, the whiskers and the inorganic binder.

Although examples of the dispersant are not particularly limited, they may include, for example, water, an organic solvent such as benzene and the like, alcohol such as methanol and the like, and dispersants of the like.

Moreover, a molding assistant may be added to the raw material paste, if necessary.

The above-mentioned molding assistant is not particularly limited, and they may include, for example, ethylene glycol, dextrin, fatty acid, fatty acid soap, polyalcohol and the like.

Next, the ceramic molded body is dried by using, for example, a microwave dryer, a hot-air dryer, a dielectric dryer, a reduced-pressure dryer, a vacuum dryer, a freeze dryer and the like, to prepare a ceramic dried body.

Thereafter, the resulting ceramic dried body is subjected to a degreasing process and a firing process under predetermined conditions, so that a honeycomb unit 20 which contains at least inorganic fibers and/or whiskers in addition to inorganic particles, and is composed of a single sintered body in its entire structure, can be manufactured.

The degreasing process of the ceramic dried body is carried out, for example, at about 400° C. for about 2 hours. Most of the organic binder and the like are thereby volatilized, decomposed and eliminated.

The firing process is carried out by heating at a temperature in the range of about 600 to about 1200° C.

When the firing temperature is in the range of about 600 to about 1200° C., it is possible to sufficiently progress the sintering of ceramic particles and the like, leading to increase in the strength of the honeycomb structured body. Further, the sintering of ceramic particles and the like is prohibited from progressing too much, leading to increase in the specific surface area per unit volume, and a catalyst component is sufficiently dispersed in a high level at the time of supporting the catalyst component.

Here, the more desirable firing temperature is in the range of about 600 to about 1000° C.

The method for applying a catalyst to the alumina film of the honeycomb unit include, for example, a method in which the ceramic fired body is impregnated with diammine dinitro platinum nitric acid solution ([Pt (NH₃)₂(NO₂)₂]HNO₃; platinum concentration: 4.53% by weight) and the like, and heated thereafter, and of the like methods.

Incidentally, application of the above catalyst to the honeycomb unit is carried out after forming the alumina film on the honeycomb unit.

Next, a sealing material paste for forming a sealing material layer 11 is applied with an even thickness to the side faces of the honeycomb unit 20 to form a sealing material paste layer, and a process in which another honeycomb unit 20 is successively piled up on the sealing material paste layer is repeated so that a honeycomb unit aggregated body having a predetermined size is fabricated.

Since the explanation for the material for forming the sealing material paste has already been given, the detailed description thereof will be omitted here.

Next, this honeycomb unit aggregated body is dried and solidified through the heating of the sealing material paste layers, so that the sealing material layers 11 are formed.

By using a diamond cutter and the like, the honeycomb unit aggregated body in which a plurality of honeycomb units 20 are bonded to one another through the sealing material layers 11 is subjected to a cutting process such that each sealing material layer 11 between the honeycomb units 20 on the cross section perpendicular to the longitudinal direction is formed diagonal to the major axis of a shape that constitutes the contour of the cross section; thus, a flat-shaped honeycomb block 15 is fabricated.

Compared with a method in which a honeycomb block having a predetermined shape is prepared by combining and bonding to one another honeycomb units manufactured in various shapes, the manufacturing process can be simplified when the honeycomb block is manufactured through this cutting process.

By forming a sealing material layer 12 on the outer periphery of the honeycomb block 15 by using the sealing material paste, it is possible to manufacture a honeycomb structured body 10 in which a sealing material layer 12 is formed on the outer peripheral portion of the flat-shaped honeycomb block 15 in which a plurality of honeycomb units 20 are bonded to one another through the sealing material layers 11.

Although the use of the honeycomb structured body of the present invention is not particularly limited, it is desirable to be used for exhaust gas conversion of vehicles.

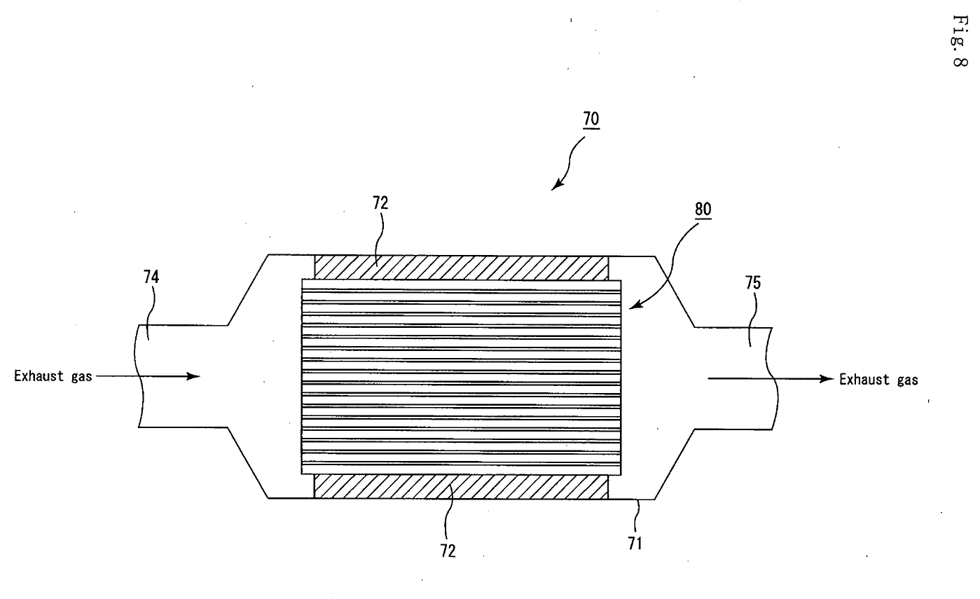

FIG. 8 is a cross-sectional view that schematically shows one example of an exhaust gas conversion device for a vehicle with the honeycomb structured body of the present invention installed therein.

As shown in FIG. 8, an exhaust gas conversion device 70 is mainly constituted by a honeycomb structured body 80, a casing 71 that covers the periphery of the honeycomb structured body 80, and a holding sealing material 72 that is placed between the honeycomb structured body 80 and the casing 71; and connected to one end of the casing 71 on the exhaust gas inlet side is an introducing pipe 74, which is connected to an internal combustion system such as an engine, and connected to the other end of the casing 71 is an exhaust pipe 75 connected to the outside. Moreover, the arrows in FIG. 8 show flows of exhaust gases.

Furthermore, in FIG. 8, the honeycomb structured body 80 may be prepared as the honeycomb structured body 10 shown in FIG. 3 or as the honeycomb structured bodies 30, 40 or 50 shown in FIGS. 5 to 7. In these cases, however, the casings need to be formed into shapes which fit each of the shapes of the honeycomb structured bodies.

In the exhaust gas conversion device 70 having the above-mentioned configuration, exhaust gases discharged from the internal combustion system such as an engine, are directed into the casing 71 through the introducing pipe 74, and allowed to flow into the honeycomb structured body from inlet-side cells; after having passed through the cells and being converted thereby, the exhaust gases are discharged out of the honeycomb structured body from outlet-side cells, and then discharged to the outside through the exhaust pipe 75.

Although not shown in the figures, the above-mentioned catalyst is supported on the cell walls of the honeycomb structured body.

When used as a catalyst support for exhaust gas conversion of a diesel engine, the honeycomb structured body is sometimes used together with a diesel particulate filter (DPF) that has a ceramic honeycomb structure constituted by silicon carbide and the like and also has a function of filtering and burning particulate matters (PMs) in exhaust gases, and in such a case, the positional relationship between the honeycomb structured body of the present invention and the DPF may be such that the honeycomb structured body of the present invention is placed on either the front side (proximal side with respect to the engine) or the rear side (distal side with respect to the engine) of the DPF.

When placed on the front side (proximal side), heat generated through the reaction of the honeycomb structured body of the present invention is transmitted to the DPF on the rear side (distal side), and the temperature raising process at the time of regeneration of the DPF can be accelerated. When placed on the rear side (distal side), PMs in exhaust gases are filtered through the DPF, and pass through the cells of the honeycomb structured body of the present invention thereafter; therefore, clogging hardly occurs, and gas components generated through incomplete combustion upon burning PMs in the DPF, are also processed by using the honeycomb structured body of the present invention.

### EXAMPLES

In the following, description of the present invention will be given in detail by way of examples; however, the present invention is not intended to be limited by these examples.

### Example 1

Herein, 40% by weight of γ-alumina particles (average particle diameter: 2 μm), 10% by weight of silica-alumina fibers (average fiber diameter: 10 μm, average fiber length: 100 μm, aspect ratio: 10) and 50% by weight of silica sol (solid concentration: 30% by weight) were mixed, and to 100 parts by weight of the resulting mixture were added 6 parts by weight of methyl cellulose serving as an organic binder and a slight amount of a plasticizer and a lubricant, and the mixture was further mixed and kneaded to obtain a mixed composition.

Next, this mixed composition was extrusion-molded, so that a raw molded product which had almost the same end face shape as the end face shape shown in FIG. 4A was fabricated.

Next, the above-mentioned raw molded product was dried by using a microwave dryer and the like, and thus a ceramic dried body was prepared. This was degreased at 400° C. for 2 hours, and fired at 800° C. for 2 hours thereafter, so that a honeycomb unit 20, which had a specific surface area of 42000 m²/L, a size of 34.3 mm×34.3 mm×150 mm, the number of cells 21 of 93 cells/cm² and cell walls 23 in a thickness of 0.20 mm, was manufactured.

Table 1 shows the cross-sectional area of the honeycomb unit. As shown in Table 1, the cross-sectional area of the honeycomb unit was 11.8 cm².

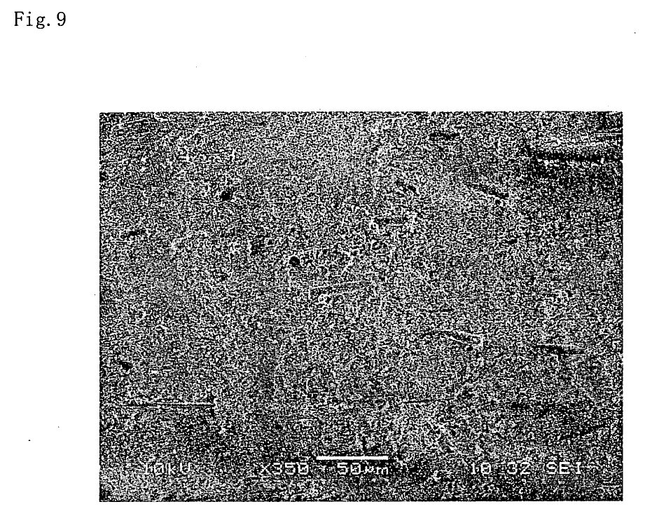

FIG. 9 shows a scanning electron microscopic (SEM) photograph of the cell walls of this honeycomb unit.

Next, 29% by weight of γ-alumina particles (average particle diameter: 2 μm), 7% by weight of silica-alumina fibers (average fiber diameter: 10 μm, average fiber length: 100 μm), 34% by weight of silica sol (solid concentration: 30% by weight), 5% by weight of carboxymethyl cellulose and 25% by weight of water were mixed to prepare a heat resistant sealing material (adhesive) paste. By using this sealing material paste, a number of honeycomb units 20 were piled up, and the resulting piled up body was cut by using a diamond cutter such that the sealing material layers between the honeycomb units were formed into a pattern as shown in FIG. 3; thus, a honeycomb block 15 having a racetrack shape in its contour of the end face was fabricated.

In this case, the sealing material layer 11 which bonds the honeycomb units 20 was adjusted such that it had the thickness of 1.0 mm.

Next, by using the same paste as the above-mentioned sealing material paste, a sealing material paste layer was formed on the outer peripheral portion of the honeycomb block 15. This sealing material paste layer was dried at 120° C. to form a sealing material layer (coat layer) 12, and thus a honeycomb structured body 10, which had a racetrack shape in its contour of the end face with 200 mm in major axis×100 mm in minor axis, and the sealing material layer (coat layer) having 0.2 mm in thickness, was manufactured. Here, the cross-sectional area of the honeycomb structured body on the cross section perpendicular to the longitudinal direction was 179 cm² and the angle which the sealing material layers between the honeycomb units on the cross section and the major axis of the shape constituting the contour of the cross section made was 5°.

Here, the cross-sectional area of this honeycomb unit was 11.8 cm² at maximum.

Here, the specific surface area of the honeycomb unit was measured by using the following method.

First, volumes of honeycomb units and sealing material layers were actually measured, and a ratio A (vol %) of the honeycomb units in the volume of the honeycomb structured body was calculated. Next, a BET specific surface area B (m²/g) per unit weight of the honeycomb unit was measured. The BET specific surface area was measured through a one-point method in compliance with JIS-R-1626 (1996) defined by Japanese Industrial Standard, by using a BET measuring device (Micromeritics FlowSorb II-2300, made by Shimadzu Corp.). Upon measuring, samples prepared by cutting out cylindrical-shaped small pieces (15 mm in diameter×15 mm in height) were used. Then, the apparent density C (g/L) of the honeycomb unit was calculated through the weight and the volume decided by the shape of the honeycomb units, and the specific surface area S (m²/L) of the honeycomb structured body was calculated from the following expression (1). Here, the specific surface area of the honeycomb structured body refers to a specific surface area per apparent volume of the honeycomb structured body.
S(m²/L)=(A/100)×B×C (1)

The contents of JIS-R-1626 (1996) are incorporated herein by reference in their entirety.

### Examples 2 to 7, Comparative Examples 1 to 3

A honeycomb structured body 10 was manufactured through the same processes as those of Example 1, except that the angle which the sealing material layers (adhesive layers) between the honeycomb units on the cross section perpendicular to the longitudinal direction and the major axis of the shape constituting the contour of the cross section make, and the maximum cross-sectional area of the honeycomb unit perpendicular to the longitudinal direction were set to values indicated by Table 1.

### Examples 8 to 14, Comparative Examples 4 to 6

A honeycomb structured body 30 was manufactured through the same processes as those of Example 1, except that the contour of the end face was formed into an elliptical shape as shown in FIG. 5, and that the angle which the sealing material layers (adhesive layers) between the honeycomb units on the cross section perpendicular to the longitudinal direction and the major axis of the shape constituting the contour of the cross section make, and the maximum cross-sectional area of the honeycomb unit perpendicular to the longitudinal direction were set to values indicated by Table 1.

### Examples 15 to 21, Comparative Examples 7 to 9

A honeycomb structured body 50 was manufactured through the same processes as those of Example 1, except that the contour of the end face was formed into an almost triangular shape as shown in FIG. 6 and that the angle which the sealing material layers (adhesive layers) between the honeycomb units on the cross section perpendicular to the longitudinal direction and the major axis of the shape constituting the contour of the cross section make, and the maximum cross-sectional area of the honeycomb unit perpendicular to the longitudinal direction were set to values indicated by Table 1.

### Examples 22 and 23, Reference Examples 1 and 2

Honeycomb structured bodies 10 were manufactured through the same processes as those of Example 1, except that the maximum cross-sectional area of the honeycomb unit perpendicular to the longitudinal direction was set to values indicated by Table 1. The herein used honeycomb units perpendicular to the longitudinal direction had the cross-sectional dimensions of 2.24×2.24 cm, 7.10×7.10 cm, 2.0×2.0 cm, and 7.41×7.41 cm in Examples 22, 23, Reference Example 1, and Reference Example 2, respectively.

(Evaluation)

The honeycomb structured bodies manufactured in the Examples, the Comparative Examples and the Reference Examples were subjected to thermal shock/vibration repetitive tests and measurements on the pressure loss, by using the following methods.

[Thermal Shock/Vibration Repetitive Test]

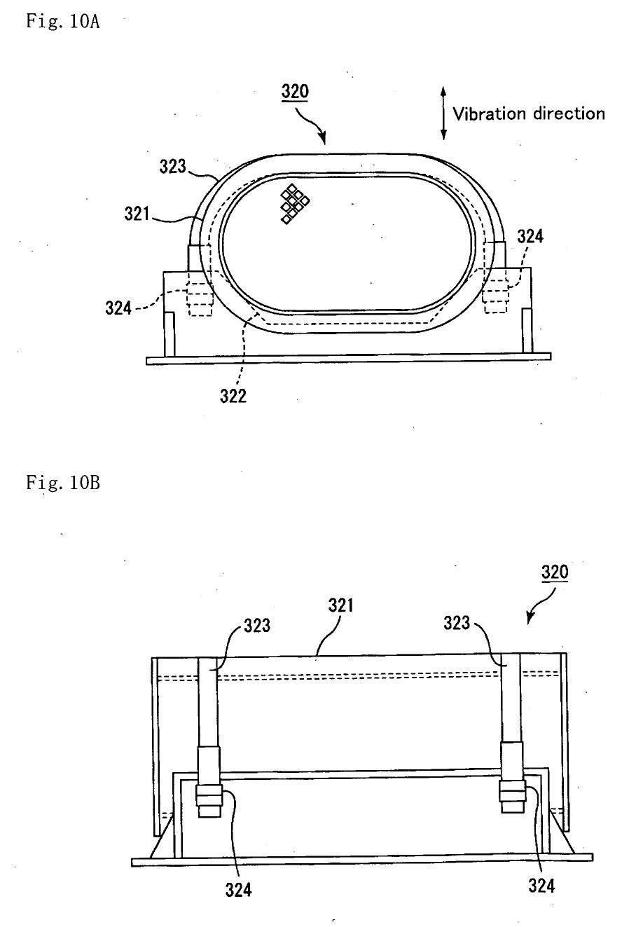

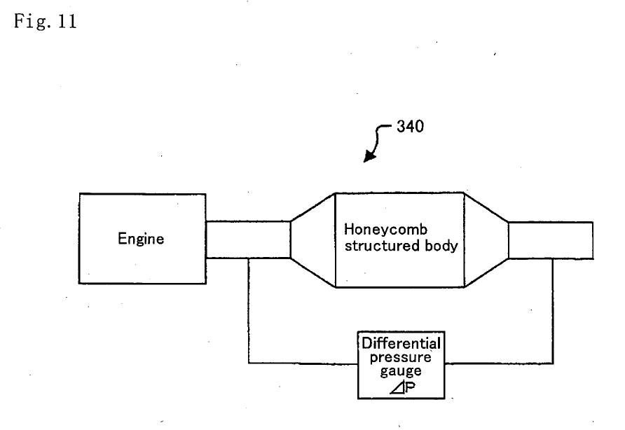

In a thermal shock test, a honeycomb structured body, being kept in a metal casing 321, with an alumina mat (MAFTEC, 46.5 cm×15 cm, thickness 6 mm, made by Mitsubishi Chemical Corp.), which is a heat-insulating material made of alumina fibers, wound around the peripheral face thereof was put into a firing furnace set at 600° C., and was heated for 10 minutes, and then taken out from the firing furnace and quenched to room temperature. Next, a vibration test was carried out by keeping the honeycomb structured body in this metal casing. FIG. 10A is a front view that shows a vibration testing device 320 used for the vibration test, and FIG. 10B is a side view that shows the vibration testing device 320. The metal casing 321 which held the honeycomb structured body therein was placed on a mount 322, and the metal casing 321 was secured thereon by tightening a securing member 323 having an almost U-shape with a screw 324. Thus, the metal casing 321 was allowed to vibrate with the mount 322 and the securing member 323 being integrally held together therewith. The vibration test was carried out under conditions of a frequency of 160 Hz, an acceleration of 30 G, an amplitude of 0.58 mm and a retention time of 10 hr, at room temperature, and in a vibration direction of the Z-axis direction (up and down). 10 times each of these thermal shock test and vibration test were repeated alternately, and the weight T0 before the tests and the weight Ti after the tests were measured, and the weight reduction ratio G was calculated by using the following expression (2).
G (wt %)=100×(T0−Ti)/T0 (2)

The metal casings used in this test had respective shapes such that honeycomb structured bodies having respective shapes could fit in.

[Pressure Loss Measurement]

A pressure-loss measuring device 340 is shown in FIG. 11. In this measuring method, a honeycomb structured body with an alumina mat being wound thereon, which was put into a metal casing, was placed in an exhaust pipe of a common rail-type diesel engine of 2L, and pressure meters were attached to front and rear sides of the honeycomb structured body. With respect to the measuring conditions, the engine revolution was set to 1500 rpm and the torque was set to 50 Nm, and a differential pressure after a lapse of 5 minutes from the start up was measured.

TABLE 1

| | | | | Reduction ratio G after | |
|---|---|---|---|---|---|
| | | Maximum cross- | | thermal shock/ | Pressure |
| | Cross-sectional shape of | sectional area | Angle | vibration tests | loss |
| | honeycomb structured body | (cm²) | (°) | (wt %) | (kPa) |
| Example 1 | FIG. 3A (racetrack shape) | 11.8 | 5 | 8 | 2.6 |
| Example 2 | FIG. 3A (racetrack shape) | 11.8 | 15 | 5 | 2.6 |
| Example 3 | FIG. 3A (racetrack shape) | 11.8 | 30 | 0 | 2.6 |
| Example 4 | FIG. 3A (racetrack shape) | 11.8 | 45 | 0 | 2.6 |
| Example 5 | FIG. 3A (racetrack shape) | 11.8 | 60 | 0 | 2.6 |
| Example 6 | FIG. 3A (racetrack shape) | 11.8 | 75 | 5 | 2.6 |
| Example 7 | FIG. 3A (racetrack shape) | 11.8 | 85 | 9 | 2.6 |
| Comparative | FIG. 3A (racetrack shape) | 11.8 | 0 | 22 | 2.6 |
| Example 1 | | | | | |
| Comparative | FIG. 3A (racetrack shape) | 11.8 | 3 | 18 | 2.6 |
| Example 2 | | | | | |
| Comparative | FIG. 3A (racetrack shape) | 11.8 | 88 | 19 | 2.6 |
| Example 3 | | | | | |
| Example 8 | FIG. 5 (elliptical shape) | 11.8 | 5 | 7 | |
| Example 9 | FIG. 5 (elliptical shape) | 11.8 | 15 | 0 | |
| Example 10 | FIG. 5 (elliptical shape) | 11.8 | 30 | 0 | |
| Example 11 | FIG. 5 (elliptical shape) | 11.8 | 45 | 0 | |
| Example 12 | FIG. 5 (elliptical shape) | 11.8 | 60 | 0 | |
| Example 13 | FIG. 5 (elliptical shape) | 11.8 | 75 | 3 | |
| Example 14 | FIG. 5 (elliptical shape) | 11.8 | 85 | 6 | |
| Comparative | FIG. 5 (elliptical shape) | 11.8 | 0 | 25 | |
| Example 4 | | | | | |
| Comparative | FIG. 5 (elliptical shape) | 11.8 | 3 | 20 | |
| Example 5 | | | | | |
| Comparative | FIG. 5 (elliptical shape) | 11.8 | 88 | 18 | |
| Example 6 | | | | | |
| Example 15 | FIG. 6 (almost triangular | 11.8 | 5 | 9 | |
| | shape) | | | | |
| Example 16 | FIG. 6 (almost triangular | 11.8 | 15 | 5 | |
| | shape) | | | | |
| Example 17 | FIG. 6 (almost triangular | 11.8 | 30 | 0 | |
| | shape) | | | | |
| Example 18 | FIG. 6 (almost triangular | 11.8 | 45 | 0 | |
| | shape) | | | | |
| Example 19 | FIG. 6 (almost triangular | 11.8 | 60 | 0 | |
| | shape) | | | | |
| Example 20 | FIG. 6 (almost triangular | 11.8 | 75 | 4 | |
| | shape) | | | | |
| Example 21 | FIG. 6 (almost triangular | 11.8 | 85 | 8 | |
| | shape) | | | | |
| Comparative | FIG. 6 (almost triangular | 11.8 | 0 | 23 | |
| Example 7 | shape) | | | | |
| Comparative | FIG. 6 (almost triangular | 11.8 | 3 | 17 | |
| Example 8 | shape) | | | | |
| Comparative | FIG. 6 (almost triangular | 11.8 | 88 | 20 | |
| Example 9 | shape) | | | | |
| Example 22 | FIG. 3A (racetrack shape) | 5.0 | 45 | 0 | 2.7 |
| Example 23 | FIG. 3A (racetrack shape) | 50.0 | 45 | 3 | 2.5 |
| Reference | FIG. 3A (racetrack shape) | 4.0 | 45 | 0 | 3.0 |
| Example 1 | | | | | |
| Reference | FIG. 3A (racetrack shape) | 55.0 | 45 | 40 | 2.5 |
| Example 2 | | | | | |

As clearly indicated by Table 1, those honeycomb structured bodies according to the Examples in which the sealing material layers between the honeycomb units on a cross section perpendicular to the longitudinal direction were formed such that their directions are diagonal to the major axis of a shape constituting the contour of the cross section, exerted excellent durability to thermal shock and vibration, and in contrast, those honeycomb structured bodies according to the Comparative Examples in which the sealing material layers between the honeycomb units on a cross section perpendicular to the longitudinal direction were formed such that their directions are almost perpendicular to the major axis of a shape constituting the contour of the cross section, were inferior in durability to thermal shock and vibration in comparison with the honeycomb structured bodies according to the Examples. The reason for this is presumably because cracks occurred in the sealing material layers between the honeycomb units and the sealing material layer formed on the outer periphery thereof.

Moreover, in the honeycomb structured body according to Reference Example 1 in which the honeycomb unit has a cross-sectional area of less than 5 cm² (4 cm²), the pressure loss was high in comparison with other honeycomb structured bodies according to the Examples.

In the honeycomb structured body according to Reference Example 2 in which the honeycomb unit has a cross-sectional area exceeding 50 cm² (55 cm²) , although the sealing material layers were formed diagonally, there was degradation in the durability against thermal shock and vibration in comparison with other honeycomb structured bodies according to the Examples. The reason for this is presumably because the honeycomb units were too large that they failed to sufficiently alleviate thermal shock imposed on the honeycomb unit.

Moreover, the honeycomb structured bodies according to the Examples make it possible to maintain a high specific surface area.

What is claimed as new and desired to be secured by Letters Patent of the United States is:

1. A honeycomb structured body comprising:
a honeycomb block which has a flat-shaped cross section and has a structure in which plural honeycomb units are bonded to one another through sealing material layers, each unit having in the longitudinal direction a large number of cells placed in parallel with a cell wall therebetween, and
a sealing material layer provided on an outer peripheral portion of said honeycomb block,
wherein
each of said honeycomb units comprises inorganic fibers and/or whiskers in addition to inorganic particles, and
said sealing material layer which is formed between said honeycomb units on the cross section perpendicular to the longitudinal direction is formed such that the direction thereof is diagonal to the major axis of a shape constituting the contour of said cross section.

2. The honeycomb structured body according to claim 1,
wherein
the cross-sectional area on a cross section perpendicular to the longitudinal direction of said honeycomb unit is about 5 to about 50 cm².

3. The honeycomb structured body according to claim 2,
wherein
the cross-sectional area on a cross section perpendicular to the longitudinal direction of said honeycomb unit is about 6 to about 40 cm².

4. The honeycomb structured body according to claim 2,
wherein
the cross-sectional area on a cross section perpendicular to the longitudinal direction of said honeycomb unit is about 8 to about 30 cm².

5. The honeycomb structured body according to claim 1,
wherein
the smaller of the angles of which the sealing material layer between said honeycomb units on the cross section perpendicular to the longitudinal direction and the major axis of the shape constituting the contour of the cross section make is within the range of about 5 to about 85°.

6. The honeycomb structured body according to claim 5,
wherein
the smaller of said angles is within the range of about 15 to about 75°.

7. The honeycomb structured body according to claim 5,
wherein
the smaller of said angles is within the range of about 30 to about 60°.

8. The honeycomb structured body according to claim 1,
wherein
said sealing material layer has a thickness of about 0.5 to about 2 mm.

9. The honeycomb structured body according to claim 1,
wherein
the total sum of cross-sectional areas of said honeycomb units on the cross section perpendicular to the longitudinal direction accounts for about 85% or more of the cross-sectional area of said honeycomb structured body on the cross section perpendicular to the longitudinal direction.

10. The honeycomb structured body according to claim 1,
wherein
said inorganic particles comprise of at least one member selected from the group consisting of alumina, silica, zirconia, titania, ceria, mullite and zeolite.

11. The honeycomb structured body according to claim 1,
wherein
said inorganic fibers and/or whiskers comprise of at least one member selected from the group consisting of alumina, silica, silicon carbide, silica-alumina, glass, potassium titanate and aluminum borate.

12. The honeycomb structured body according to claim 1,
wherein
said honeycomb unit is manufactured by using an inorganic binder.

13. The honeycomb structured body according to claim 12,
wherein
said inorganic binder comprises of at least one member selected from the group consisting of alumina sol, silica sol, titania sol, water glass, sepiolite and attapulgite.

14. The honeycomb structured body according to claim 1, on which a catalyst is supported.

15. The honeycomb structured body according to claim 14,
wherein
said catalyst contains at least one member selected from the group consisting of noble metal, alkali metal, alkaline earth metal and oxide.

16. The honeycomb structured body according to claim 1,
wherein
said sealing material layer comprises at least inorganic fibers and/or inorganic particles in addition to inorganic binder.

17. The honeycomb structured body according to claim 16,
wherein
said inorganic binder comprises silica sol and/or alumina sol.

18. The honeycomb structured body according to claim 16,
wherein
said sealing material layer is manufactured by using inorganic fibers and/or inorganic particles in addition to an inorganic binder and an organic binder.

19. The honeycomb structured body according to claim 16,
wherein
said inorganic fibers comprise at least one member selected from the group consisting of silica-alumina fibers, mullite fibers, alumina fibers and silica fibers.

20. The honeycomb structured body according to claim 16,
wherein
inorganic particles comprise at least one member selected from the group consisting of oxides, carbides and nitrides.

21. The honeycomb structured body according to claim 16,
wherein
said sealing material layer further comprises at least one member selected from the group consisting of balloons, spherical acrylic particles and graphite.

22. The honeycomb structured body according to claim 21,
wherein
said balloons comprise at least one member selected from the group consisting of alumina balloons, glass micro-balloons, shirasu balloons, fly ash balloons (FA balloons) and mullite balloons.

23. The honeycomb structured body according to claim 18,
wherein
said organic binder comprises at least one member selected from the group consisting of polyvinyl alcohol, methyl cellulose, ethyl cellulose and carboxymethyl cellulose.

24. The honeycomb structured body according to any of claims 1 to 23, which is used for exhaust gas conversion of a vehicle.

25. A manufacturing method of a honeycomb structured body which comprises
a honeycomb block which has a flat-shaped cross section and has a structure in which plural honeycomb units are bonded to one another through sealing material layers, each unit having in the longitudinal direction a large number of cells placed in parallel with a cell wall therebetween, and
a sealing material layer provided on an outer peripheral portion of said honeycomb block,
wherein
said honeycomb block which has a flat-shaped cross section is fabricated by subjecting said plural honeycomb units bonded to one another to a cutting process such that each sealing material layer between said honeycomb units on the cross section perpendicular to the longitudinal direction is diagonal to the major axis of a shape constituting the contour of the cross section.
